(19) United States
(12) Patent Application Publication
(10) Pub. No.: US 2004/0193654 A1
(43) Pub. Date: Sep. 30, 2004

(54) Logical range logging

(76) Inventors: Nitzan Peleg, Haifa (IL); Yuval Sherman, Sunnyvale, CA (US)

Correspondence Address: HEWLETT-PACKARD COMPANY, Intellectual Property Administration, P.O. Box 272400, Fort Collins, CO, 80527-2400, US

(21) Appl. No.: 10/403,499

(22) Filed: Mar. 31, 2003

(51) Int. Cl. G06F 17/30

(52) U.S. Cl. 707/200

(57) ABSTRACT

The disclosed embodiments may relate to a system for performing logical range logging. The system may include a refresh log that may contain entries and a database management system (“DBMS”) that may read the refresh log and employ buffers to perform a refresh operation on a table using the entries. The DBMS may determine if a last row of a previous one of the plurality of buffers is allocated and assign a status attribute for the last row of the previous buffer if the previous buffer is allocated. The DBMS may determine if a current row in a current buffer is a last row to be inserted into the table as part of the refresh operation.

### BACKGROUND OF THE RELATED ART

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

When changes are made to tables in a database, a database management system (“DBMS”) that manages the database may create and/or update a log showing the changes. Periodically, the DBMS may use the information contained in the log to update or refresh materialized views that have data derived from a particular base table. The DBMS may include a refresh manager portion that is responsible for updating the log and periodically performing updates to materialized views based on the information stored in the log.

When large amounts of data are inserted into a base table, logging the entire data set of inserted rows may have at least two disadvantages. One disadvantage may be a reduction in performance suffered by applications updating base tables because computing resources are busy doing the bulk data transfer when data is written to the log in addition to the base table. For example, an updating application that might ordinarily take an expected time (for instance, 30 seconds) may take about twice as long because of the logging operation. With range logging, however, the insert operation may take only a little longer than the expected time. A second disadvantage of bulk data transfers is that they may require a significant amount of disk space. Disk space may be wasted because the same data may be redundantly stored in two separate tables (the base table and the refresh log).

Range logging may be used to optimize writes made to a base table. With range logging, only the clustering keys of the first and last rows in contiguous logical ranges may be logged, rather than the associated data. At refresh time, a join operation between the log and the base table may be performed in order to read all the base table rows that are part of ranges logged in the log. Range logging, however, may only be efficient in situations where a few large ranges have been logged, but not for many small ranges.

However, range logging may suffer from shortcomings, as well. One potential shortcoming is that range logging would have to take into account the actual order of the rows being inserted, as well as any interleaving with existing rows in the table. Failure to do so may result in a refresh operation re-applying rows to a materialized view during a refresh operation. This could result in incorrect data in a materialized view.

Additionally, if a DBMS supports range logging on entry sequenced tables only, insert operations may only be performed as append operations. If only append operations are supported, range logging for key sequenced tables may not be possible. This is true because insert operations may require interleaving with existing table rows instead of appending entries to the end of the existing table.

### BRIEF DESCRIPTION OF THE DRAWINGS

Advantages of one or more disclosed embodiments may become apparent upon reading the following detailed description and upon reference to the drawings in which:

FIG. 1 is a block diagram illustrating a computer network in accordance with embodiments of the present invention;

FIG. 2 is a block diagram illustrating a refresh operation in accordance with embodiments of the present invention;

FIG. 3 is a block diagram illustrating a refresh log in accordance with embodiments of the present invention;

FIG. 4 is a process flow diagram that shows a single row insert operation in accordance with embodiments of the present invention; and

FIG. 5 is a process flow diagram that shows a buffered insert operation in accordance with embodiments of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

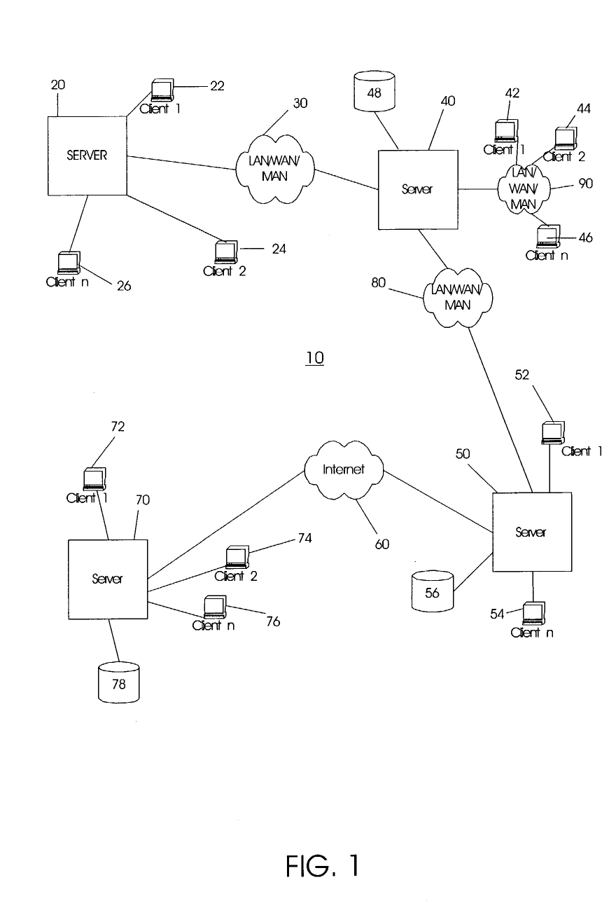

Turning now to the drawings and referring initially to FIG. 1, a block diagram of a computer network architecture is illustrated and designated using a reference numeral 10. A server 20 may be connected to a plurality of client computers 22, 24 and 26. The server 20 may be connected to as many as “n” different client computers. Each client computer in the network 10 may be a functional client computer. The magnitude of “n” may be a function of the computing power of the server 20. If the server 20 has large computing power (for example, faster processor(s) and/or more system memory), it may be able to effectively serve a number of client computers.

The server 20 may be connected via a network infrastructure 30, which may include any combination of hubs, switches, routers, and the like. While the network infrastructure 30 is illustrated as being either a local area network (“LAN”), storage area network (“SAN”) a wide area network (“WAN”) or a metropolitan area network (“MAN”), those skilled in the art will appreciate that the network infrastructure 30 may assume other forms or may even provide network connectivity through the Internet. As described below, the network 10 may include other servers, which may be dispersed geographically with respect to each other to support client computers in other locations.

The network infrastructure 30 may connect the server 20 to server 40, which may be representative of any other server in the network environment of server 20. The server 40 may be connected to a plurality of client computers 42, 44, and 46. As illustrated in FIG. 1, a network infrastructure 90, which may include a LAN, a WAN, a MAN or other network configuration, may be used to connect the client computers 42, 44 and 46 to the server 40. A storage device 48 such as a hard drive, storage area network (“SAN”), RAID array or the like may be attached to the server 40. The storage device 48 may be used to store a database or portion of a database for use by other network resources. A database partition may be stored on the storage device 48 as a portion of a distributed, shared-nothing database.

In databases that contain large amounts of data, it may take a relatively long time to perform a query. This may have an adverse impact on the performance or response time of the database as a whole. If the database is subject to a large number of complex queries, the response time for each query may be seriously lengthened. If a view requires information from several tables or is frequently requested by users, the view may be created as a “materialized view” to improve the performance of the database. When a view is materialized, it may actually be stored as a separate table within the database. Queries may then be run against the materialized view without incurring processing time penalties for reassembling the information contained in the materialized view each time a query that may be satisfied by the materialized view is performed.

The server 40 may be adapted to create log files for updating materialized views that may be stored on the storage device 48. For example, the server 40 may be adapted to identify Insert/Update or Delete operations made to base tables that affect the materialized view and create a log entry with a timestamp indicating when the operation to the base table occurred.

The server 40 may additionally be connected to server 50, which may be connected to client computers 52 and 54. A network infrastructure 80, which may include a LAN, a WAN, a MAN or other network configuration, which may be used to connect the client computers 52, 54 to the server 50. The number of client computers connected to the servers 40 and 50 may depend on the computing power of the servers 40 and 50, respectively. A storage device 56 such as a hard drive, storage area network (“SAN”), RAID array or the like may be attached to the server 50. The storage device 56 may be used to store a database or portion of a database for use by other network resources. A database partition may be stored on the storage device 56 as a portion of a distributed, shared-nothing database.

The server 50 may be adapted to create log files for updating materialized views that may be stored on the storage device 56. For example, the server 50 may be adapted to identify Insert/Update or Delete operations made to base tables that affect the materialized view and create a log entry with a timestamp indicating when the operation to the base table occurred.

The server 50 may additionally be connected to the Internet 60, which may be connected to a server 70. The server 70 may be connected to a plurality of client computers 72, 74 and 76. The server 70 may be connected to as many client computers as its computing power may allow. A storage device 78 such as a hard drive, storage area network (“SAN”), RAID array or the like may be attached to the server 40. The storage device 78 may be used to store a database or portion of a database for use by other network resources. A database partition may be stored on the storage device 78 as a portion of a distributed, shared-nothing database.

The server 70 may be adapted to create log files for updating materialized views that may be stored on the storage device 78. For example, the server 70 may be adapted to identify Insert/Update or Delete operations made to base tables that affect the materialized view and create a log entry with a timestamp indicating when the operation to the base table occurred.

Those of ordinary skill in the art will appreciate that the servers 20, 40, 50, and 70 may not be centrally located. Accordingly, the storage devices 48, 56 and 78 may also be at different locations. A network architecture, such as the network architecture 10, may typically result in a wide geographic distribution of computing and database resources.

The use of databases in a networked computing environment may be an important tool in a modern business environment. A database may be described as a collection of related records or tuples of information or data. A relational database is a popular type of database. In a relational database, a structured set of tables or relations is defined. The tables may be populated with rows and columns of data. The entire collection of tables makes up a relational database.

A database may be accessed through an application program, which may be referred to as a database management system or “DBMS.” The DBMS may be a program that allows users to add new data to the database or access data that is already stored in the database. The DBMS may also perform database management functions. An access to the database may be called a “query.” A query may be performed across an entire relational database and may request data from one or more tables within the database. The organization of the data requested by a query may be called a “view.” Views may not exist independently within the database, but may only exist as the output from a query.

In a networked computing environment, the information stored in a database may not all be in a centralized location. Portions of data in a single relational database may be stored on different servers on different network segments, or even in different cities or countries. To make processing the information faster, a relational database may be partitioned among a number of servers to allow parallel processing of queries.

If a database contains large amounts of data, it may take a relatively long time to perform a query. This may have an adverse impact on the performance or response time of the database as a whole. If the database is subject to a large number of complex queries, the response time for each query may be seriously lengthened. If a view requires information from several tables or is frequently requested by users, the view may be created as a “materialized view” to improve the performance of the database. When a view is materialized, it may actually be stored as a separate table within the database. Queries may then be run against the materialized view without incurring processing time penalties for reassembling the information contained in the materialized view each time a query that may be satisfied by the materialized view is performed. When a materialized view is created, it may be designated to be refreshed periodically to reflect changes to the base tables from which the materialized view draws data.

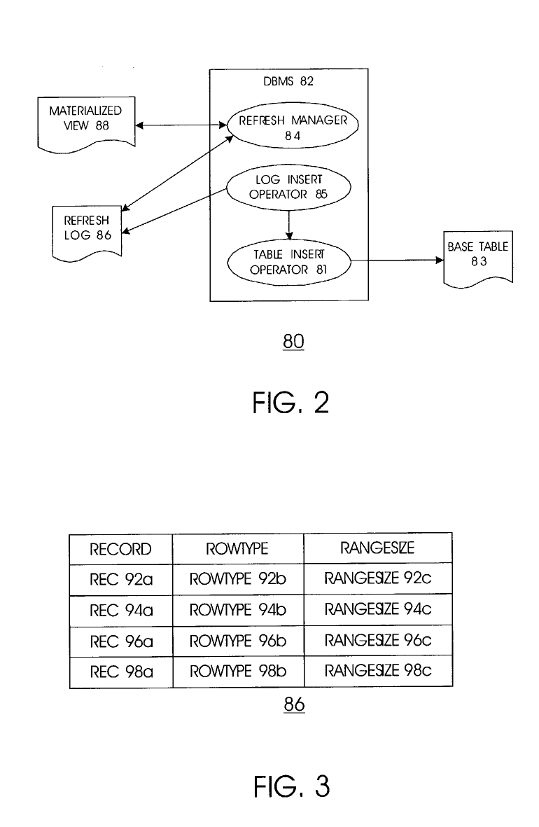

FIG. 2 is a block diagram illustrating a refresh operation in accordance with embodiments of the present invention. The reference numeral 80 refers generally to the elements shown in FIG. 2. The network architecture 10 (FIG. 1) may include a DBMS 82 that may be adapted to create log files for updating materialized views that may be stored on storage devices within the network 10. The DBMS 82 may include a refresh manager 84 that may automatically perform the functions of maintaining a refresh log 86 and updating a materialized view 88. The materialized view is in part derived from a base table 83. The DBMS may include a base table insert operator 81 to perform updates on the base table 83 and supply information to a refresh log insert operator 85. The refresh log insert operator 85 may provide updates to the refresh log 86. The refresh log 86, the base table 83 and the materialized view 88 may be stored on one or more of the storage devices 48, 56 and/or 78 of the network architecture 10.

The refresh manager 84 may be adapted to identify Insert/Update or Delete (“IUD”) operations made to the base table 83 if those IUD operations affect the materialized view 88 and control the creation of a log entry in the refresh log 86 indicating the nature of the modification to the base table 83. The creation of an entry in the refresh log 86 may be performed automatically as a part of an IUD operation on the underlying base table.

Logging operations may be one of two different types. The first type of logging operation may be for operations on single rows (where each row in the base table may be identified by a primary key value). The second type of logging operation may be for new ranges in the base table primary key that result from bulk inserts. A new range is a range in the primary key that was empty of data prior to a large insert operation. The new range may be locked during the bulk insert. The refresh manager 84 may be adapted to perform range logging to optimize logging time and disk space requirements. Logging information may be retrieved from a range in the refresh log 86 by joining the range and the associated base table.

The base table insert operator 81 provides output that is used by the refresh log insert operator 85 to update the refresh log 86 in response to IUD operations that occur on the base table 83. A buffer may be a contiguous block of memory used for sending the rows to be inserted into the refresh log insert operator 85, as well as the output data. The rows in the buffer may be assumed to be ordered according to the primary key of the base table 83.

An interleaved existing row may be a row that was stored in the base table 83 before the insert operation started, and according to its primary key value, is ordered between two rows in the buffer. A block may be a subset of the rows passed in a buffer that have no interleaving existing rows between them. A range may be a subset of the data set, contained in one or more blocks (each one from a separate buffer), that constitutes a logical range of rows, with no interleaving existing rows between them. The output from the base table insert operator 81, is inserted into the refresh log table 86, and may later be used to update the materialized view 88 in accordance with embodiments of the present invention.

FIG. 3 is a block diagram illustrating a refresh log in accordance with embodiments of the present invention. In FIG. 3, the partial excerpt of a refresh log corresponds to the refresh log 86 in FIG. 2. Because the refresh log contains information about Insert, Update and Delete (“IUD”) operations, the refresh log may also be referred to as an IUD log. The information shown in the log excerpt 86 in FIG. 3 is an example of the information that may be included in such a log. Those of ordinary skill in the art will appreciate that various combinations of data, including additional data may exist in actual refresh logs.

The refresh log 86 may include a record identifier for each entry. In FIG. 3, the record identifier is identified by reference numerals 92a-98a. Each record in the refresh log 86 may also include a RowType field and a RangeSize field. Entries in the RowType field for each record are identified by the reference numerals 92b-98b and entries in the RangeSize field are identified by the reference numerals 92c-98c.

The RowType field may have one of four values: “Single,” “BeginRange,” “EndRange,” and “Ignore.” The RowType value of “Single” may indicate that the row is not part of a range. For a RowType value of Single, the RangeSize may have a value of one (“1”). The RowType value of BeginRange may correspond to the first row of a given range, with a RangeSize value of zero (“0”). The RowType value of EndRange may correspond to the last row of a range. The RangeSize corresponding to an EndRange RowType may correspond to the number of rows inserted as part of a given range. A RowType field value of “Ignore” may be used to indicate that a row is within a range, and need not be inserted into the refresh log 86. The RangeSize value associated with an Ignore RowType value may be zero. A computation of the sum on the RangeSize column for the entire data set may result in the actual number of rows inserted.

A B-Tree insert operation may be used to detect the existence of interleaving existing rows within a range and report the ranges accordingly. A B-tree data structure may relate to the type of indexing scheme used by a DBMS. In a B-tree index, a tree structure of index entries and index blocks may be used to organize data into ascending or descending order. A B-tree index may provide for efficient searching for a single data value or a range of data values. Additionally, many small, local ranges may be united into fewer large ranges to help make the refresh operation more efficient.

Embodiments of the present invention may employ a B-Tree software component, which may encapsulate operations on the B-Tree data structure used for maintaining a Structured Query Language (“SQL”) table on disk or other storage medium. Instead of actively detecting range boundaries, embodiments of the present invention may utilize the fact that the B-Tree maintenance algorithms discover this information during the insertion of the data. The interface to the B-Tree software component is used to retrieve information about the constituency of ranges and use that information for range logging.

Two B-Tree methods that may be incorporated into embodiments of the present invention may be the single row insert and the buffered insert. In a bulk insert operation, first the single row insert method is called for the first one or more rows in a given buffer. When the B-Tree software component recognizes that a buffered insert may be used, it may return a Range Protector Key (“RPK”). Once the RPK is acquired, a buffered insert may be performed until all data has been inserted into the appropriate base table or until an interleaving existing row is encountered. In the latter case, a non-acknowledge (“NAK”) condition may be returned by the buffered insert method, and the following rows in the buffer may be inserted using the single row insert method until another RPK is acquired.

When all the rows in a given buffer have been inserted, output data projection from the base table insert operator 81 to the refresh log insert operator 85 is initiated. After the last buffer of data, the insert operator may receive an End-Of-Data (“EOD”) signal, notifying it that no more data will be arriving.

The range may be considered to be open from the moment the RPK is acquired until the insertion of rows into that range ends by a NAK situation or by signaling to the B-Tree software component that there is no more data to be inserted. During the time that the range is open, it is also locked, so that no other transaction can access rows in it.

Embodiments of the present invention may not only detect the existence of local ranges within inserted buffers (blocks), but also may unite as many blocks as possible to larger logical ranges. This may be done to promote the efficiency of the refresh operation. The use of a few large ranges may be more efficient than the use of many small ranges. A vector of status information may be maintained for each row of the buffer. The vector may be updated to the correct values during an insert operation. Additionally, the status information in the vector may be projected as part of the output projection operation of the base table insert operator 81 (FIG. 2) to the refresh log insert operator 85 (FIG. 2).

When the single insert method returns an RPK, the current row from the refresh log 86 may be marked as BeginRange. A count of the number of rows inserted as part of the currently open range may be maintained after every call to the buffered insert method. When the buffered insert method returns a NAK condition, the last row inserted may be marked with a RowType of EndRange and a counter value may be used as the RangeSize value for that row. However, when a range is open after inserting the last row of the buffer, it may still be unknown whether that row should be marked as EndRange or not because the data of the next buffer may not have arrived yet. Therefore, the last row of every buffer, unless it is not part of an open range, may be saved in a local buffer, and not projected with the rest of the data. That row may be projected as part of the next buffer, when its status has become clear. Because the row will only be projected when all the data in the next buffer has been inserted (the last row of that buffer may also need to be saved), another such local buffer may be used.

Embodiments of the present invention may take into account several special cases. One special case may occur when an RPK is acquired on the last row of the buffer. In this situation, a buffered insert may only be called for the data in the next buffer. In such a case, the row saved in the local buffer may indeed be a BeginRange row.

Another special situation may occur when a buffered insert operation returns a NAK condition on the first row of the buffer. That row may be marked as EndRange as it may actually be the last row of the previous buffer. However, if that row is marked as BeginRange, it may mean that the range consists of a single row only, so that row may be marked with a RowType of Single instead.

Embodiments of the present invention may comprise several component parts, each of which may be executed at a particular time. Examples of these components may include (a) initialization for each new buffer, (b) processing after calling single row insert, (c) processing after calling buffered insert, (d) projecting the output data, and (e) processing when EOD is encountered (following the last row to be inserted).

Embodiments of the present invention may include the state variables shown in Table 1:

TABLE 1

| | |
|---|---|
| rowCounter_{—} | May be an integer keeping the count of rows in |
| | the currently open range |
| rowStatusVector_{—} | May include an entry for the RowType and |
| | RangeSize of each row in the current buffer |
| lastRowOfThisBuffer_{—} | May be a memory pointer to the last row of the |
| | current buffer and its RowType |
| lastRowOfPrevBuffer_{—} | May be a memory pointer to the last row of the |
| | previous buffer and its RowType |

The underscore following the variable name indicates that the variables are state variables rather than temporary variables.

With respect to buffer initialization, the RowStatusVector may be allocated (or reused from the previous buffer). All buffer entries may be initialized by setting each RowType field to a value of Ignore and each RangeSize field to a value of zero.

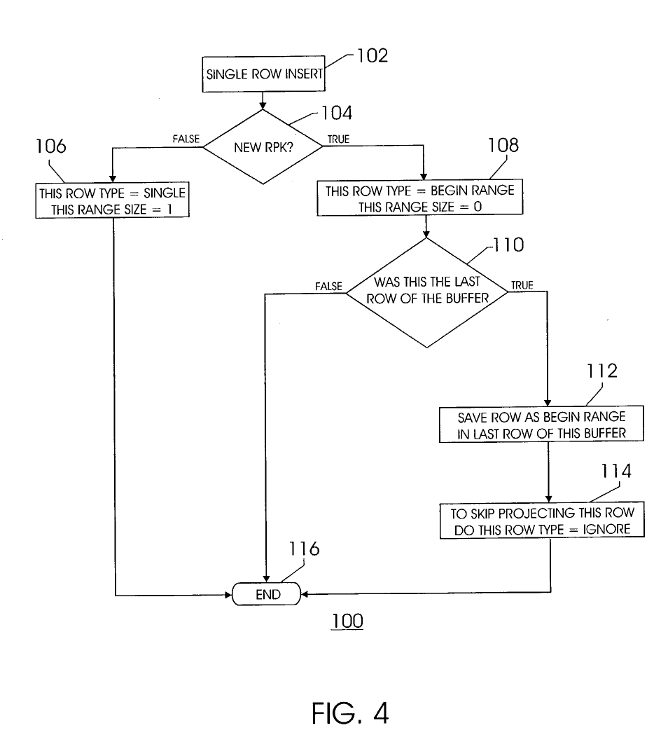

FIG. 4 is a process flow diagram that shows the processing after calling the single row insert operation in accordance with embodiments of the present invention. The process is generally referred to by the reference numeral 100. The process shown in FIG. 4 may be performed after each call to the single row insert method.

At block 102, the process begins when the single row insert method is called. The variables thisRowType and thisRangeSize may represent the RowType and RangeSize fields of the rowStatus_ Vector entry corresponding to the current row in rowStatusVector_. At block 104, a decision is made about whether a new RPK has been received. If a new RPK has not been received, then the current row may be marked as a Single row, with a RangeSize of one as shown at block 106. Otherwise, the current row may be marked as BeginRange, with a RangeSize of zero as shown at block 108.

A check is then made to determine if the current row is the last row of the buffer, as shown at block 110. If the row is the last row of the buffer, that row is saved in a lastRowOfThisBuffer variable with a RowType of BeginRange, as shown at block 112. At block 114, the current row in the buffer is marked as Ignore, so that it will not be projected as part of the current buffer. At block 116, the process ends.

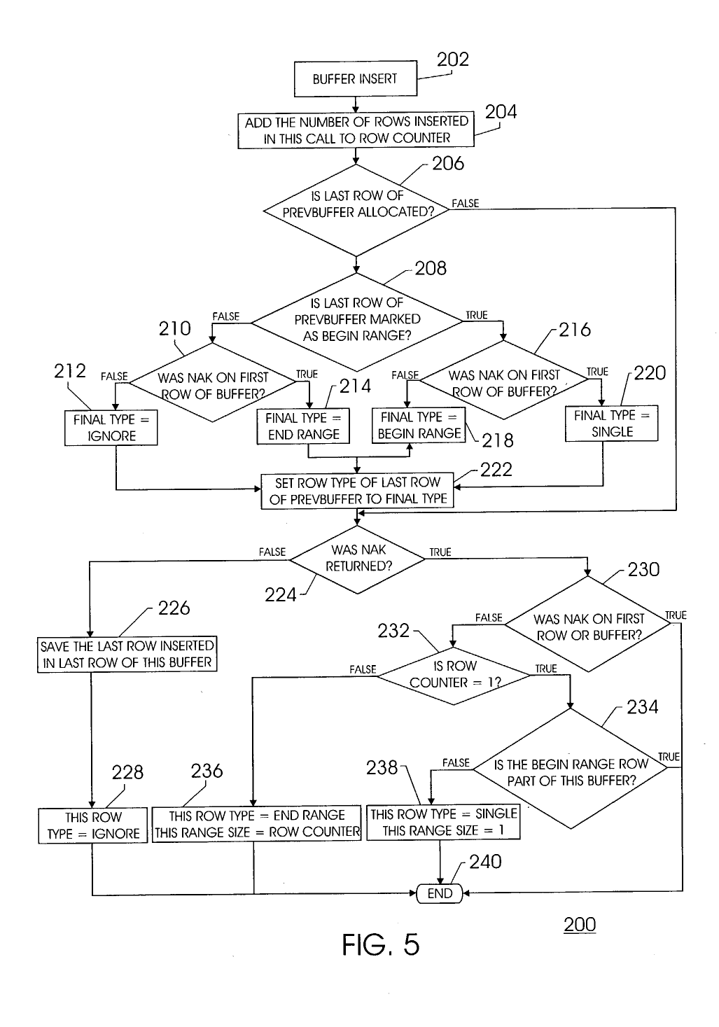

FIG. 5 is a process flow diagram that shows the processing done after calling the buffered insert operation in accordance with embodiments of the present invention. The process is generally referred to by the reference numeral 200. At block 202, the process begins, when the buffered insert method is called. The process shown in FIG. 5 may be thought of as occurring in two parts. In the first part, if lastRowOfPreviousBuffer_ is allocated, its final RowType is determined. In the second part, a determination is made about the status of the current row in the buffer to see whether it is the last row inserted by the buffered insert method.

At block 204, the size of the currently open range is updated by adding the number of rows inserted in this call to the buffered insert method to the value of the rowCounter_ state variable. At block 206 a determination is made about whether the lastRowOfPreviousBuffer is allocated. In coming to decide on the status of the last row of the previous buffer, two factors may be considered: (1) whether the row is marked as BeginRange (block 208), and (2) whether a NAK was returned on the first row of the buffer, so that the last row of the previous buffer is actually the last row of the current range (blocks 210, 216). The four options for these factors are set forth in Table 2:

TABLE 2

| Was NAK on | Last row of | |
|---|---|---|
| first row of | previous buffer | |
| buffer? (blocks | was Ignore (block | Last row of previous buffer |
| 210, 216)? | 210) | was BeginRange (block 216) |
| No | finalType =Ignore | finalType =BeginRange (block |
| | (block 212) | 218) |
| | (common case) | The range that started on the |
| | Ordinary buffer | last row of the previous buffer |
| | row | continued in the current buffer |
| Yes | finalType =EndRange | finalType =Single |
| | (block 214) | (block 220) |
| | The rows of this | The range had only |
| | buffer are not part | one row in it. |
| | of the current | |
| | range, so the range | |
| | ended in the last | |
| | row of the | |
| | previous buffer | |

At block 222, the RowType for lastRowOfPrevBuffer_ may be set to the value of finalType from Table 2.

Beginning at block 224, the status of the last row inserted is determined. If a NAK condition was not returned, then all the rows in the buffer were inserted, and the range is still open. The last row of this buffer may be saved (block 226) and in the buffer it may be marked as Ignore (block 228). In this case the entry may not be projected as part of the output from this buffer.

If a NAK is returned , a determination is made about whether it was returned on the first row of this buffer (block 230). If so, the situation has already been dealt with previously (blocks 210, 216). No rows from the current buffer may be affected.

If a NAK was returned on any but the first row of the buffer (block 230 is evaluated as false), and rowCounter_ is greater than one (block 232 is evaluated as false), then this is the end of a range. The last row inserted may be marked as EndRange and rowCounter_ may be used as the RangeSize (block 236).

If a NAK was returned on any but the first row of the buffer (block 230 is evaluated as false) and rowCounter_ is equal to one (block 232 is evaluated as true) then a range consisting of a single row has ended. If the row that started this range (the row that acquired the RPK) was part of this buffer (block 234 is evaluated as false) then mark the row as Single, with a RangeSize of one. If the row, however, was part of the previous buffer (block 234 is evaluated as true), then the situation has already been dealt with previously. None of the rows of the current buffer may be affected.

With respect to projecting the output data, if lastRowOfPrevBuffer_ is allocated, that row may be projected as output and the pointer may be released. Additionl rows may be projected, as well. Finally, if lastRowOfThisBuffer_ is allocated, that row may be assigned to lastRowOfPrevBuffer_ and lastRowOfThisBuffer_ may be released.

With respect to receipt of an End-of-data (“EOD”) message, that message may be the signal that all the data to be inserted has already arrived and has been processed. The last row to be projected may be stored in lastRowOfPrevBuffer_(if it is allocated). If the RowType of this row is BeginRange, then it may be set to Single (with a RangeSize of one) because this condition may mean that the range started on the last row of the previous buffer (the buffer only includes the current row). Otherwise, the RowType field may be set to EndRange, and rowCounter_ may be used as the RangeSize value. The row may then be projected as output.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A system for performing logical range logging, the system comprising:
a refresh log that contains a plurality of entries; and
a database management system (“DBMS”) to read the refresh log and employ a plurality of buffers, including a previous and a current buffer, to perform a refresh operation on a table using the plurality of entries, the DBMS being adapted to:
determine if a last row of a previous one of the plurality of buffers is allocated;
assign a status attribute for the last row of the previous buffer if the previous buffer is allocated; and
determine if a current row in a current buffer is a last row to be inserted into the table as part of the refresh operation.

2. The system set forth in claim 1, wherein the DBMS outputs the current row in the current buffer depending on the determination of whether the current row in the current buffer is the last row to be inserted.

3. The system set forth in claim 1, wherein the DBMS determines whether a non-acknowledge condition (“NAK”) was returned when the last row of the previous buffer was projected as output.

4. The system set forth in claim 1, wherein the DBMS determines whether the previous buffer comprised a single row.

5. The system set forth in claim 1, wherein the DBMS determines whether the last row of the previous buffer was the beginning of a logical range.

6. The system set forth in claim 1, wherein the plurality of entries each contains a row type attribute and a range size attribute.

7. A system for performing logical range logging, the system comprising:
a refresh log that contains a plurality of entries; and
a database management system (“DBMS”) that reads the refresh log and employ a plurality of buffers to perform a refresh operation on a table using the plurality of entries, the DBMS being adapted to:
determine if a Range Protector Key (“RPK”) is received in response to a row being projected as output from one of the plurality of buffers;
project a current row of a current one of the plurality of buffers as output as a single row if an RPK was not received;
save the current row of the current buffer as a last row of the current buffer and not project the current row of the current buffer as output if an RPK was received and the current row of the current buffer is the last row of the current buffer.

8. The system set forth in claim 7, wherein the RPK is generated by a B-Tree software component.

9. The system set forth in claim 7, wherein the plurality of entries each contains a row type attribute and a range size attribute.

10. A method of performing logical range logging in a computer system, the computer system comprising a refresh log that contains a plurality of entries and a database management system (“DBMS”) that reads the refresh log and employs a plurality of buffers to perform a refresh operation on a table using the plurality of entries, the method comprising:
determining if a last row of a previous one of the plurality of buffers is allocated;
assigning a status attribute for the last row of the previous buffer if the previous buffer is allocated;
determining if a current row in a current buffer is a last row to be inserted into the table as part of the refresh operation to create a status attribute associated with the current row of the current buffer; and
projecting the current row of the current buffer as output depending on the status attribute associated with the current row of the current buffer.

11. The method set forth in claim 10, comprising determining whether a non-acknowledge condition (“NAK”) was returned if the last row of the previous buffer was projected as output.

12. The method set forth in claim 10, comprising determining whether the previous buffer comprised a single row.

13. The method set forth in claim 10, comprising determining whether the last row of the previous buffer was the beginning of a logical range.

14. The method set forth in claim 10, wherein the recited acts are performed in the recited order.

15. A method of performing logical range logging in a computer system, the computer system comprising a refresh log that contains a plurality of entries and a database management system (“DBMS”) that is adapted to read the refresh log and employ a plurality of buffers to perform a refresh operation on a table using the plurality of entries, the method comprising:
determining whether a Range Protector Key (“RPK”) is received in response to a row being projected as output from one of the plurality of buffers;
outputting a current row of a current one of the plurality of buffers as a single row if an RPK was not received; and
saving the current row of the current buffer as a last row of the current buffer and not projecting the current row of the current buffer as output if an RPK was received and the current row of the current buffer is the last row of the current buffer.

16. The method set forth in claim 15, comprising employing a B-Tree software component to generate the RPK.

17. The method set forth in claim 15, wherein the recited acts are performed in the recited order.

18. A computer system, comprising:
a database;
a refresh log that contains a plurality of entries; and
a database management system (“DBMS”) to manage the database, to read the refresh log and to employ a plurality of buffers, including a previous and a current buffer, to perform a refresh operation on a table of the database using the plurality of entries, the DBMS being adapted to:
determine if a last row of a previous one of the plurality of buffers is allocated;
assign a status attribute for the last row of the previous buffer if the previous buffer is allocated; and
determine if a current row in a current buffer is a last row to be inserted into the table as part of the refresh operation.

19. The computer system set forth in claim 18, wherein the DBMS outputs the current row in the current buffer depending on the determination of whether the current row in the current buffer is the last row to be inserted.

20. The computer system set forth in claim 18, wherein the DBMS determines whether a non-acknowledge condition (“NAK”) was returned when the last row of the previous buffer was projected as output.

21. The computer system set forth in claim 18, wherein the DBMS determines whether the previous buffer comprised a single row.

22. The computer system set forth in claim 18, wherein the DBMS determines whether the last row of the previous buffer was the beginning of a logical range.

23. The computer system set forth in claim 18, wherein the plurality of entries each contains a row type attribute and a range size attribute.

24. A computer system, comprising:
a database;
a refresh log that contains a plurality of entries; and
a database management system (“DBMS”) to manage the database and to read the refresh log and employ a plurality of buffers to perform a refresh operation on a table using the plurality of entries, the DBMS being adapted to:
determine if a Range Protector Key (“RPK”) is received in response to a row being projected as output from one of the plurality of buffers;
project a current row of a current one of the plurality of buffers as output as a single row if an RPK was not received;
save the current row of the current buffer as a last row of the current buffer and not project the current row of the current buffer as output if an RPK was received and the current row of the current buffer is the last row of the current buffer.

25. The computer system set forth in claim 24, wherein the RPK is generated by a B-Tree software component.

26. The computer system set forth in claim 24, wherein the plurality of entries each contains a row type attribute and a range size attribute.
